(19) United States
(12) Patent Application Publication
(10) Pub. No.: US 2005/0016165 A1
(43) Pub. Date: Jan. 27, 2005

(54) Method of storing and transporting wind generated energy using a pipeline system

(76) Inventors: Ben M. Enis, Henderson, NV (US); Paul Lieberman, Torrance, CA (US)

Correspondence Address: Patent Office of J. John Shimazaki, P.O. Box 650741, Sterling, VA, 20165, US

(21) Appl. No.: 10/857,009

(22) Filed: Jun. 1, 2004

Related U.S. Application Data
(60) Provisional application No. 60/474,551, filed on May 30, 2003.

(51) Int. Cl. F16D 31/02

(52) U.S. Cl. 60/398

(57) ABSTRACT

The invention relates to a method of using a pipeline system for storing and transporting compressed air energy generated by wind turbines, wherein the pipeline preferably extends along a predetermined route, between a remote location where wind conditions are relatively consistent and predicable, and a power grid or community needing the power located a distance away. The remote location is preferably provided with a large number of windmill stations for generating electrical and mechanical energy, which is used to compress air into the pipeline. The route is preferably extended along an existing road or easement, and can incorporate abandoned existing piping when available. Turbo expanders and alternators are preferably provided at the user end of the pipeline, to release the compressed air and generate electricity for the grid or community.

### RELATED APPLICATION

This application claims priority from U.S. provisional application Ser. No. 60/474,551, filed on May 30, 2003.

### FIELD OF THE INVENTION

The present invention relates to a method of storing and transporting energy, and in particular, to a method of storing and transporting wind generated energy using a pipeline system extended along a predetermined route.

### BACKGROUND OF THE INVENTION

Generating energy from natural sources, such as from the sun and wind, has been an important objective in this country over the last several decades. Indeed, reducing reliance on oil, such as from foreign sources, has become an important national issue. Energy experts fear that some of these resources, including oil, gas and coal, may someday run out. Because of these concerns, many projects have been initiated in an attempt to harness energy derived from what are called natural “alternative” sources.

While solar power may be the most widely known alternative source, there is also the potential for harnessing tremendous energy from the wind. Wind farms, for example, have been built in many areas of the country where the wind naturally blows. In many of these applications, a large number of windmills are built and “aimed” toward the wind. As the wind blows against the windmills, rotational power is created and then used to drive electric generators. This energy is often used to supplement energy produced by utility power plants and distributed by electric power grids.

Wind farms are best operated when wind conditions are relatively constant and predictable. Such conditions enable a consistent and predictable amount of energy to be generated and supplied, thereby avoiding surges and swings that could adversely affect the attached system networks. Because the amount of wind-generated power is a function of the cube of the wind speed, the amount of power that can ultimately be generated at any given time is subject to wind fluctuations and oscillations, which are unpredictable, uncertain and undesirable.

This is particularly significant in the context of using a power grid, which is a giant network composed of a multitude of smaller networks. When wind power is supplied to a grid, sudden surges in one area can upset other areas, and can even bring down the entire system in some cases. Typical wind farm power outputs are often difficult to deal with because of these variances.

Additional problems relating to the peak power sensitivity of the transmission lines can also occur. When wind speed fluctuations are significant, and substantial wind power output fluctuations occur, the transmission lines must be designed with enough line capacity to account for the extreme maximum of these variances. This effect is said to reduce the “capacitance” of the cable transmission system.

One potential solution that has been attempted has been to store the energy generated by wind so that it can be used at peak demand periods and periods when little or no wind is available, i.e., time shifting. Nevertheless, storage of wind-generated energy has presented its own difficulties in terms of cost and effectiveness. Attempts in the past have included using underground caverns as a means of storing compressed air energy. Large high-pressure storage tanks have also been built, but these systems are costly to construct.

For these reasons, it has been highly desirable to find locations for wind farms where the wind is moderately predictable and constant, over extended periods of time, so that less reliance on energy storage is necessary. The additional problem this has created, however, is that in many cases, these locations are far from existing electrical power grids and communities where power is needed. Accordingly, there is often the additional problem of getting the power generated by wind to the locations where the power is needed, i.e., through a distribution network of some kind.

For example, in some situations, the ideal location for wind farms may be located at the top of a hill or mountain, which might be many miles away from the city that needs the power. In such case, it would be extremely expensive to require power transmission lines to be built to transmit electrical power generated by wind from the source to the user. In addition, it is often necessary to obtain permission from local communities to install power transmission towers, which are not only unsightly and potentially harmful, but the process of obtaining approval to build them can be time consuming and costly.

Notwithstanding these problems, because wind is a significant natural resource that will never run out, and is often in abundance in many locations throughout the world, there is a desire to try to develop a system that can not only harness the power generated by wind to provide electrical power, but to do so consistently and predictably and in a cost effective and efficient manner, by enabling wind farms to be located close to where wind conditions are ideal, while at the same time, allowing wind energy to be transported to locations where the energy is needed, without having to extend lengthy and expensive power transmission lines, or having to build expensive compressed air storage tanks.

### SUMMARY OF THE INVENTION

The present invention relates to wind powered energy generating and storing systems capable of transporting wind generated energy from areas where wind conditions are ideal, to areas where energy is needed, without having to extend lengthy and expensive power transmission lines from the source to the grids or communities that need the power, and without having to build expensive compressed air storage tanks. The present system preferably comprises selecting an area where the wind conditions are likely to be consistent and predictable, or at least more so than other areas that are available, which would be suitable for generating wind energy. By their very nature, these areas are often located many miles from communities where people live, and far from existing power grids. They may, for example, be located in deserts, canyons, offshore areas, and on mountain or hilltops far from civilization.

The present method encompasses making use of wind energy in preferably ideal conditions, by locating wind farms, or a series of windmill stations, in locations where wind conditions are ideally suited to generating a consistent and predictable amount of power (such as those areas listed above). Although all locations suffer from some unpredictability and uncertainty, there are clearly locations that are better than others, and the present method preferably takes into account the use of these preferred locations.

Another aspect of the present invention relates to the use of windmill stations that are dedicated to creating either electrical or mechanical energy, including those that can be used to generate electrical energy for immediate use, and those that harness the mechanical rotational energy created by the wind to generate mechanical energy, wherein the energy produced thereby can be used to compress air into storage. The system is preferably designed with a predetermined number and ratio of windmill station types to enable the system to be both economical and energy efficient in generating the appropriate amount of wind energy, although virtually any type of windmill or wind turbine can be used, i.e., that are capable of generating energy to compress air.

In this respect, the present application incorporates by reference in its entirety previous U.S. patent application Ser. No. 10/263,848, which discusses methods and apparatuses for using wind turbines to generate and supply power, and previous U.S. provisional application Ser. No. 60/478,220, which discusses different types of wind turbine systems to coordinate and stabilize power. These methods and systems are preferably used in connection with the present invention to supply uninterrupted and stabilized power to the user.

A unique aspect of the present invention relates to the use of a pipeline system (preferably but not necessarily underground) into which the compressed air from each windmill station can be channeled, wherein the pipeline can be used to not only store the compressed air, but also transport the compressed air energy from one remote location (where wind conditions are ideal) to where the energy is needed (a town, city or power grid). Storage of compressed air in this manner allows the energy derived from the wind to be stored for a period of time until it is needed and utilized. The pipeline can also be used as a means of transporting the stored energy, from where the wind farm is located, to the location where the energy is needed, wherein the pipeline itself can serve as both storage and transportation means.

For example, the pipeline can be buried in the ground and extended between the windmill stations, i.e., the wind farm, and the grid or community where the energy is needed, which can be a distance of many miles. By storing energy in this fashion, the compressed air is stored in and transported through the pipeline system along a planned route, wherein the stored air can be released at the opposite end of the pipeline, such as with a turbo expander and alternator, to generate electrical power for the grid or community needing the power. Thus the wind turbines and compressors are preferably located at one end of the pipeline, and the turbo expanders and alternators are preferably located at the opposite end of the pipeline.

Another preferred aspect of Applicant's invention takes into account the following: When determining the location of the wind farm, as well as where the pipeline is to be located, the method preferably takes into account existing roads, easements, underground pipes, lines, cables, etc., and where they are located, so that the pipeline can be laid along the most economical and/or convenient path possible. That is, the pipeline is preferably located along a direct line or path extended along, or at least in close proximity to, existing roads, easements, pipes, conduits, cables, etc., so that new roads, access, and open areas, etc., do not have to be built, and so that existing easements, land use permits, environmental impact reports, etc., can be used or relied upon in installing the new pipeline. In fact, where there are abandoned pipe systems, such as natural gas or sewer lines, the present invention preferably reuses the existing pipes, in whole or in part, as well as their easements, access areas, roads, etc., to more economically install the pipeline system.

Another key aspect of the invention is the determination of the appropriate amount of energy storage capacity needed to operate the system efficiently, and then appropriating the proper amount of storage space within the pipeline to accommodate the expected loads. A first calculation is preferably made to determine the approximate amount of storage volume or space that is needed by the system, followed by determining the length of the pipeline that will be laid between the wind farm and where the pipeline connects to the grid or community, and then determining the air pressure and size (diameter) of the pipe needed to provide the appropriate amount of storage space for the system. This way, the entire pipeline system can be designed for the specific loads that will be required, without any further need for building additional pipeline grids or networks, or any extra storage tanks, which can increase the cost thereof. This is unlike Tackett, U.S. Pat. No. 4,118,637, which shows a grid or network of pipes for storing energy, and specifies the largest possible commercially available pipe-size.

The present invention also contemplates using additional windmill stations with compressors or other means of repeating the application of pressure into the pipeline intermittently along the pipeline route. This way, as friction inside the pipeline causes pressure to drop, i.e., as the distance from the wind farm increases, additional pressure can be introduced into the pipeline, to continue to provide a stable source of compressed air energy that can be used continuously by the grid or community. Additional wind farms, such as those located in other remote locations, which are connected to the pipeline, can also be used to provide additional compressed air energy into the system.

At the opposite “user” end of the pipeline, turbo expanders and alternators are preferably provided for enabling the compressed air to be released and expanded to generate electricity, such that the stored energy can be used to drive an electrical generator, wherein energy derived from the wind can be used to generate electrical power on an “as needed” basis, i.e., when the power is actually needed, which may or may not coincide with when the wind actually blows.

Preferably, a series of servo check valves, gages and control logic are provided along the pipeline, so that the amount and rate at which the compressed air is stored and released can be controlled and monitored. In this respect, to properly apportion the amount of energy being supplied using the present system, it is necessary to know how much compressed air energy is available, by determining how much pressure is actually being introduced into the pipeline at any given time, and then being able to determine and control how much energy is being released at the appropriate rate and location.

The use of an underground pipeline formed along a planned route has several advantages:

First, the thermal inertia of the wall thickness of the pipeline, as well as the ground covering the pipe, provides a useful means of absorbing and releasing heat which can be used to prevent the system from freezing during expansion and over-heating during compression.

Second, by doing the calculations discussed above, the proper amount, size and distance of piping can be used, so that an appropriate system can be laid out from end to end, that is designed efficiently without having to construct additional grids and networks of pipes, or extra storage means.

Third, where existing roads or easements are available, such as where underground lines, cables, etc., are located, the system preferably utilizes the existing roads, easements and access areas, etc., to more efficiently and economically install the new pipeline.

Fourth, where abandoned piping systems, such as natural gas lines, sewer lines or other piping are already in existence, the system can economically reuse the existing pipes, in whole or in part, to more economically provide the necessary storage and transportation capacities for the system.

### BRIEF DESCRIPTION OF THE DRAWINGS

FIG. 1 shows a wind farm located in a remote location connected by a pipeline system extending along a planned route, such as along an existing road or easement, between the wind farm and town or grid, whereby compressed air energy from the wind farm can be stored and transported by the pipeline to the town or grid; and

FIG. 2 shows two wind farms located in remote locations connected by a pipeline system extending along a planned route, such as along an existing road or easement, between the wind farms and town or grid, wherein additional windmill stations are provided along the planned route to provide intermittent sources of compressed air energy to maintain air pressure along the route.

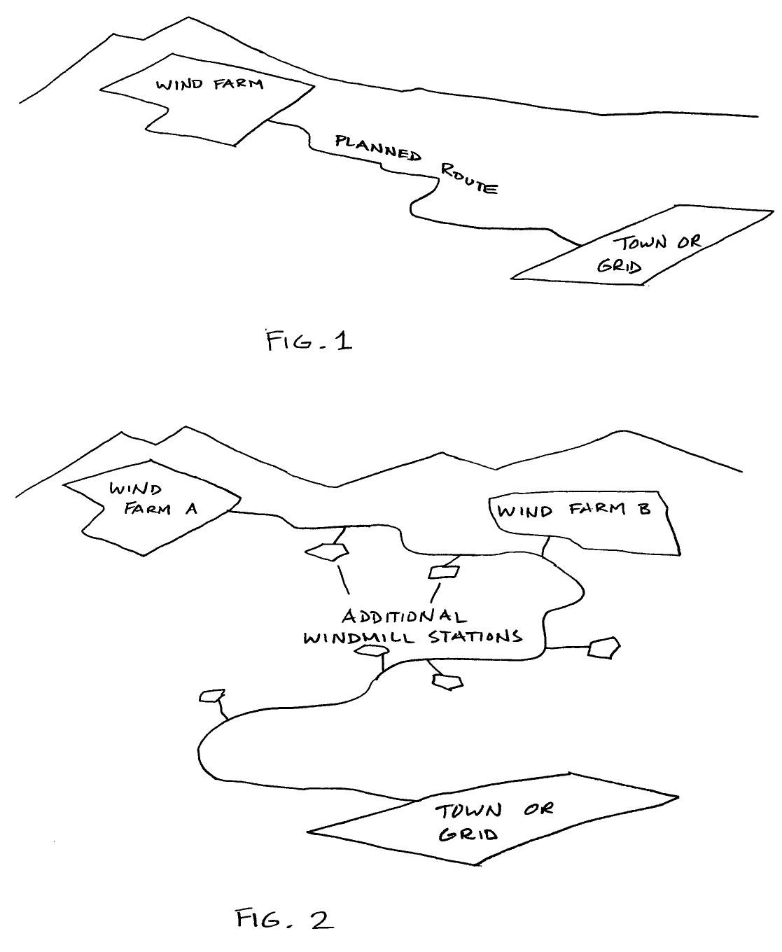

### DETAILED DESCRIPTION OF THE INVENTION

The present invention relates to wind powered energy generating and storing systems capable of transporting wind generated energy from areas where wind conditions are ideal, to areas where energy is needed, without having to extend lengthy and expensive power transmission lines to grids or communities, and without having to build expensive compressed air storage tanks, etc.

The present system preferably comprises selecting an area where the wind conditions are likely to be consistent and predictable, or at least more so than other areas that are available, which would be suitable for generating wind energy. By their very nature, these areas are often located in remote areas many miles from communities where people live, and far from existing power grids. They may, for example, be located in deserts, canyons, offshore areas, and on mountain or hilltops far from civilization. They are also often located where property values are relatively low.

The present method encompasses making use of wind energy in preferred or ideal conditions, by locating large numbers of windmill stations where wind conditions are ideally suited to generating a consistent and predictable amount of electrical power. Although all locations suffer from some unpredictability and uncertainty, there are clearly locations that are better than others, and the present method preferably takes into account the use of these preferred locations.

Another preferred aspect of the present invention relates to the use of 1) windmill stations that are dedicated to creating energy for direct and immediate use (hereinafter referred to as “immediate use stations”), 2) windmill stations that are dedicated to energy storage using a compressed air energy system (hereinafter referred to as “energy storage stations”), and 3) windmill stations that can be switched between the two (hereinafter referred to as “hybrid stations”). The system is preferably designed with a predetermined number and ratio of these windmill station types to enable the system to be both economical and energy efficient in generating the appropriate amount of energy for both immediate use and storage. This embodiment is preferably used in communities where there may be a need for a large number of windmill stations, such as a large wind farm, or where there is access to an existing power grid, so that energy from the system can be used to supplement conventional energy sources.

Each immediate use station preferably has a horizontal axis wind turbine (HAWT) and an electrical generator located in the nacelle of the windmill, such that the rotational movement caused by the wind is directly converted to electrical energy via the generator. This can be done, for example, by directly connecting the electrical generator to the horizontal rotational shaft of the wind turbine so that the mechanical power derived from the wind can directly drive the generator. By locating the generator downstream of the gearbox on the windmill shaft, and by using the mechanical power of the windmill directly, energy losses typically attributed to other types of arrangements can be avoided. The electrical power generated by these stations can be used to directly power compressors that can be used to compress air energy into the connected pipeline system, or transmission lines can be provided to enable the electrical power generated by the stations to be used on an as-needed basis.

The energy storage stations are more complex in terms of bringing the mechanical rotational energy from the high above ground nacelle down to ground level as rotational mechanical energy. The horizontally oriented wind turbine of each energy storage station preferably has a horizontal shaft connected to a first gear box, which is connected to a vertical shaft extending down the windmill tower, which in turn, is connected to a second gear box connected to another horizontal shaft located on the ground. The lower horizontal shaft is then preferably connected to the compressor, such that the mechanical rotational power derived from the wind can be converted directly to compressed air energy and stored. This mechanical energy can be used to drive the compressor directly, without having to convert the mechanical energy to electrical energy first, wherein the steps of converting mechanical energy to electrical energy, that are part of the immediate use stations, can be eliminated.

One unique aspect of the present invention is the use of a pipeline system into which the compressed air from each windmill station is preferably channeled and in which the compressed air can be stored and transported. Storage of compressed air allows the energy derived from the wind to be stored for a period of time until it is needed. The pipeline is also preferably used as a means of transporting the stored compressed air energy from the wind farm to the location where the energy is needed.

For example, the pipeline can be buried in the ground and extended between the wind farm and the grid or community, which can be a distance of many miles. By storing energy in this fashion, the compressed air energy can not only be stored, but also transported through the pipeline, such that it can be released through a turboexpander and alternator to generate electrical power near the grid or community needing the power, i.e., at the opposite end of the pipeline. Thus the wind turbines and compressors are preferably located at one end of the pipeline, and the turbo expanders and alternators are preferably located at the opposite end of the pipeline. In this respect, the pipeline preferably serves as both a means of storing and transporting power.

Another preferred aspect of the invention comprises using a planned route in connection with installing the pipeline system to transport wind energy from one remote location (where wind conditions are ideal) to another location (where energy is needed). A planned route is essentially a direct line or path extending from the energy source to the user, i.e., grid or community, wherein the route preferably takes into account the most economical and/or convenient path possible. For example, in many cases, such a path preferably extends along or near an existing road, such as a service access road, that allows the pipeline to be installed along an already-cleared path, which also provides easier access to the wind farm. This also allows for easier installation of the pipeline, as well as easier access for repairs and service.

The selected path could also be routed along an existing easement, such as along an existing underground conduit, such as an electrical or gas line, sewer pipes, etc., which can reduce the cost of installing the new pipeline, since it may be possible to use and/or rely upon the existing easements, land use permits, environmental impact reports, etc., that were obtained for the existing lines, to obtain approval for the new pipeline. This will allow the pipeline to be installed faster and at a lower cost.

In cases where there is an abandoned existing underground pipe system, such as a gas or sewer line, the present invention contemplates being able to use the abandoned pipe, in whole or in part, to help form the new pipeline system, and reduce the cost thereof. In this respect, if the existing pipeline is not the correct size, or does not extend the entire length, or is not entirely abandoned, the present invention contemplates using at least a portion of the existing pipe, i.e., whatever portion can be utilized. All of the easements, land use permits and environmental impact reports that were obtained for the existing pipeline can also be used and/or relied upon for the new pipeline system.

Another key aspect of the invention is the determination of the appropriate amount of energy storage capacity needed to operate the system efficiently, and then appropriating the proper amount of storage space in the pipeline to accommodate the expected loads. A first calculation is preferably made to determine the approximate amount of storage space that is needed by the system, followed by determining the length of the pipeline that will be laid between the wind farm and where the pipeline connects to the grid or community, and then determining the air pressure and size (diameter) of the pipe needed to provide the appropriate amount of storage space for the system. This way, the entire pipeline system can be designed for the specific loads that will be required, without any further need for building additional pipeline grids or networks, which can increase the cost thereof.

Intermittently through the pipeline system, additional windmill stations with compressors or other means of repeating the application of pressure into the pipeline can be provided. This way, as friction inside the pipeline reduces air pressure, i.e., as the distance from the wind farm increases, additional pressure can be introduced into the pipeline, to continue to provide a stable source of compressed air energy that can be used continuously by the grid or community.

At the opposite end of the pipeline system, means such as turbo expanders for enabling the compressed air to be released and expanded are preferably provided, such that the stored energy can be used to drive an electric generator, wherein energy derived from the wind can be used to generate electrical power on an “as needed” basis. This can be provided when the power is actually needed, which may or may not coincide with when the wind actually blows.

Preferably, a series of servo check valves, gages and control logic are provided along the pipeline, so that the amount and rate at which the compressed air is stored and released can be controlled and monitored. In this respect, to properly apportion the amount of energy being supplied using the present system, it is necessary to know how much compressed air energy is available, by determining how much pressure is actually in the pipeline at any given time, and then being able to release it at the appropriate rate and location.

In this system it is preferably only necessary to combine the energy output of the immediate use windmill stations and the energy storage windmill stations, according to a one-hour or two-hour wind forecast, so that a near constant or slowly varying power rate can be delivered to the electric utility grid or community with only small variations in delivered power. This way, the electric utility network can easily assimilate the delivered power, without stability issues caused by interacting networks, wherein the system can provide a slowly varying power history, with few maximum peaks, that uses the capacitance of the transmission lines effectively. In this respect, it is important to note that these advantages will still accrue even when there are long periods of low wind or no wind and the windmill stations deliver no electric power to the grid.

The wind patterns in any given area of the country can change from time to time, i.e., from one season to another, from one month to another, or even from day to day, or hour to hour. At the same time, the energy demand patterns for a given location may stay relatively constant from time to time, or may change, but not, in most cases, in a manner coincident with the wind availability changes. That is, there are likely to be many times during a given year where there is a complete mismatch between wind power availability and power demand, i.e., such as where demand is high when supply is low, and where supply is high when demand is low. In this respect, the present invention contemplates that these issues can be taken into account when designing the applicable wind farm system, wherein an appropriate number of each type of windmill station can be installed so that the energy to be supplied and converted to electrical power can be provided, notwithstanding any mismatch between supply and demand.

The present invention contemplates that selecting an appropriate number of windmill stations of each type will involve a study of wind availability patterns throughout the year, at a given wind farm site, as well as the energy demand patterns and cycles that are present. In this respect, the subject matter of U.S. patent application Ser. No. 10/263,848, filed on Oct. 4, 2002, entitled “Method and Apparatus for Using Wind Turbines to Generate and Supply Uninterrupted Power to Locations Remote from the Power Grid” is incorporated herein by reference. It is contemplated that the worst case scenarios, e.g., the worst seasons or months when supply and demand are mismatched the most, should be considered in selecting the design for the system, since for the system to work properly, it must, at a minimum, be designed to provide a continuous (smooth) supply of energy during the worst mismatched periods.

Again, there will be periods where no wind generated electrical power is supplied to the grid or community. However, the system preferably remains operational in the sense that it can still supply power that is readily accepted by the transmission system and also by the electrical utility networks, except that the amplitude of the power is zero.

The present invention contemplates that the system can be configured to maximize the amount of energy that can be derived from wind energy, by taking into account when and how much wind is available at any given time, and when and how much energy is in demand at any given time, so that the system can be coordinated and operated efficiently and reliably to provide power to the power grid or community. While it is often difficult to predict when and how much the wind will blow, and the extent of the demand periods, the present invention seeks to use reliable data as a means of calculating certain averages, i.e., relating to the wind supply and energy demand, and using those averages as a means of using an iterative process to create an optimum system that can be applied to virtually any given application for the entire year.

The system preferably uses the on-site meteorological towers, past wind history of the site, and one of the currently available statistical models, to accurately forecast a specific site wind speed for more than an hour in advance, so that the release of the stored energy can be timed to produce a smooth power output when combined with the instant power release from the “immediate use stations”. Some of the efficiency factors that are preferably taken into account relate to the overall cost of constructing the system, wherein it is desirable to use the supply and demand averages to come up with the optimum number of windmill stations that have to be installed to meet the energy demands placed on the system at any given time of the year. This would involve determining how many stations should be dedicated to immediate use and energy storage, and how many hybrid stations are needed, to ensure that the system can run efficiently and effectively throughout the year.

1. A method of storing and transporting wind generated energy, comprising:
determining a first site where wind speeds are sufficient for generating wind power that is remote from a user;
providing a plurality of wind turbine stations for generating energy located at said first site;
providing at least one compressor per dedicated wind turbine associated with said plurality of wind turbine stations;
determining a planned route between said first site and a second site to be serviced by said wind turbine stations;
determining the approximate distance between said first and second sites;
providing a pipeline structure along said planned route between said first and second sites for storing compressed air energy generated by said wind turbine stations;
determining the pipe size and air pressure based on the amount of storage space that is needed within said pipeline structure, taking into account the approximate distance between said first and second sites;
extending said pipeline structure from said first site to said second site along said planned route;
providing at least one turbo expander located at or near said second site to allow said compressed air energy to be released; and
providing an electrical generator to convert said compressed air energy released by said turboexpander into electrical energy.

2. The method of claim 1, wherein said first site is located in an area that is remote from existing residences and communities, where property values are otherwise relatively low, and/or where wind speeds are generally relatively consistent and predictable when compared to other locations.

3. The method of claim 1, wherein the user is a town, city or power grid located at or connected to the second site, and wherein the pipeline structure is operatively connected to said town, city or power grid.

4. The method of claim 1, wherein the planned route is located along or in close proximity to an existing road, a path where easements have already been obtained, a path where an existing conduit is located, and/or open areas that have already been created.

5. The method of claim 1, wherein the planned route is provided along a path where an existing piping system is located, wherein the method comprises using at least a portion of the existing piping system to create the pipeline structure.

6. The method of claim 1, wherein additional wind turbines or other energy sources are provided intermittently along the planned route, to provide additional compressed air energy into the pipeline structure to maintain air pressure therein.

7. The method of claim 1, wherein a third site where wind speeds are sufficient for generating wind power is provided along said planned route and connected to said pipeline structure, and wherein said third site is provided with a plurality of wind turbine stations for generating energy located at said third site, wherein at least one compressor is provided per dedicated wind turbine associated with said plurality of wind turbine stations at said third site.

8. The method of claim 1, wherein the electrical energy is provided to the user at or in connection with said second site, wherein said second site is supplied with energy originating from said first site, without having to install additional power lines and/or transport electrical energy from said first site to said second site

9. The method of claim 1, wherein said first site is located on a platform located in a body of water, wherein said pipeline structure is extended down into the ground below said body of water, and wherein said pipeline structure is extended to said second site located on land.

10. A method of transporting wind generated energy, comprising:
determining a first site where wind speeds are sufficient for generating wind power that is remote from a user;
providing a plurality of wind turbine stations for generating energy located at said first site and providing at least one compressor associated therewith;
determining a planned route between said first site and a second site to be serviced by said wind turbine stations, wherein said planned route extends substantially along an existing path which comprises at least one taken from the following: an existing road, an existing easement, an existing conduit, an existing open access area, an existing abandoned pipeline;
providing a pipeline along said planned route between said first and second sites for storing compressed air energy generated by said wind turbine stations and transporting the compressed air energy from said first site to said second site;
providing at least one turbo expander to release said compressed air energy from the pipeline structure at or near said second site;
providing an electrical generator to convert the compressed air energy released by said turbo expander into electrical energy; and
providing said electrical energy to a user at said second site.

11. The method of claim 10, wherein at least one compressor is provided per dedicated wind turbine associated with said plurality of wind turbine stations.

12. The method of claim 10, wherein the method comprises the step of determining the pipe size and air pressure based on the amount of storage space that is needed within said pipeline structure, taking into account the approximate distance between said first and second sites.

13. The method of claim 10, wherein said first site is located in an area that is remote from existing residences and communities, where property values are otherwise relatively low, and/or where wind speeds are generally relatively consistent and predictable when compared to other locations.

14. The method of claim 10, wherein the user is a town, city or power grid located at or in connection with the second site, and wherein the pipeline structure is operatively connected to said town, city or power grid.

15. The method of claim 10, wherein the planned route is provided along a path where an existing pipe system is located, wherein the method comprises using at least a portion of the existing pipe system to create the pipeline structure.

16. The method of claim 10, wherein additional wind turbines or other energy sources are provided intermittently along the planned route, to provide additional compressed air energy into the pipeline structure to maintain air pressure therein.

17. The method of claim 10, wherein a third site where wind speeds are sufficient for generating wind power is provided along said planned route and connected to said pipeline structure, and wherein said third site is provided with a plurality of wind turbine stations for generating energy located at said third site.

18. A method of using an existing pipeline system to enable wind generated energy to be stored and transported from a first location to a second location, comprising:
providing at least one wind turbine station for generating energy located at said first location and providing at least one compressor associated with said at least one wind turbine station;
operatively connecting said compressor with said existing pipeline system to enable compressed air energy generated by said wind turbine station to be introduced into said existing pipeline system;
providing for the communication of said compressed air energy through said existing pipeline system from said first location to said second location;
providing at least one turbo expander for releasing said compressed air energy at or near said second location;
providing an electrical generator to convert said compressed air energy being released by said turboexpander into electrical energy; and
providing for the use of said electrical energy in said second location, wherein said second location is supplied with energy originating from said first location, without having to transport electrical energy from said first location to said second location.
